(19) United States
(12) Patent Application Publication
(10) Pub. No.: US 2002/0100697 A1
(43) Pub. Date: Aug. 1, 2002

(54) Gas sensor with uniform heating and method of making same

(76) Inventors: David B. Quinn, Grand Blanc, MI (US); David K. Chen, Rochester Hills, MI (US)

Correspondence Address: VINCENT A. CICHOSZ, DELPHI TECHNOLOGIES, INC., P.O. Box 5052, Mail Code: 480-414-420, Troy, MI, 48007-5052, US

(21) Appl. No.: 09/741,732

(22) Filed: Dec. 19, 2000

(51) Int. Cl. G01N 27/407

(52) U.S. Cl. 205/784; 204/408; 204/426

(57) ABSTRACT

A method of making a gas sensor is disclosed, comprising disposing an electrochemical cell comprising a sensing electrode and a reference electrode disposed in ionic communication with and on opposite sides of an electrolyte layer. A first insulating layer is disposed in contact with the sensing electrode. A second insulating layer is disposed in contact with the reference electrode. A first protective insulating layer and a first heater are disposed in contact and in thermal communication with the first insulating layer. A second protective insulating layer and a second heater are disposed in contact with and in thermal communication with the second insulating layer. The method includes forming a sensor and co-firing the sensor. A gas sensor is also disclosed as being made according to the above-referenced method.

### TECHNICAL FIELD

The present disclosure relates to gas sensors, and more particularly to uniform heating of an oxygen sensor.

### BACKGROUND

The automotive industry has used exhaust gas sensors in vehicles for many years to sense the composition of exhaust gases, namely, oxygen. For example, a sensor is used to determine the exhaust gas content for alteration and optimization of the air to fuel ratio for combustion.

One type of sensor uses an ionically conductive solid electrolyte between porous electrodes. For oxygen, solid electrolyte sensors are used to measure oxygen activity differences between an unknown gas sample and a known gas sample. In the use of a sensor for automotive exhaust, the unknown gas is exhaust and the known gas, (i.e., reference gas), is usually atmospheric air because the oxygen content in air is relatively constant and readily accessible. This type of sensor is based on an electrochemical galvanic cell operating in a potentiometric mode to detect the relative amounts of oxygen present in an automobile engine's exhaust. When opposite surfaces of this galvanic cell are exposed to different oxygen partial pressures, an electromotive force (“emf”) is developed between the electrodes according to the Nernst equation.

With the Nernst principle, chemical energy is converted into electromotive force. A gas sensor based upon this principle typically consists of an ionically conductive solid electrolyte material, a porous electrode with a porous protective overcoat exposed to exhaust gases (“exhaust gas electrode”), and a porous electrode exposed to a known gas' partial pressure (“reference electrode”). Sensors typically used in automotive applications use a yttria stabilized zirconia based electrochemical galvanic cell with porous platinum electrodes, operating in potentiometric mode, to detect the relative amounts of a particular gas, such as oxygen, that is present in an automobile engine's exhaust. Also, a typical sensor has a ceramic heater attached to help maintain the sensor's ionic conductivity. When opposite surfaces of the galvanic cell are exposed to different oxygen partial pressures, an electromotive force is developed between the electrodes on the opposite surfaces of the zirconia wall, according to the Nemst equation:

$$E = ( \frac{- RT}{4 F} ) ln ( \frac{{P}_{{O}_{2}}^{ref}}{{P}_{{O}_{2}}} )$$

$$\text{where} \text{:}$$

$$\begin{matrix}E = electromotive force \\ R = universal gas constant \\ F = Faraday constant \\ T = absolute temperature of the gas \\ {P}_{{O}_{2}}^{ref} = oxygen partial pressure of the reference gas \\ {P}_{{O}_{2}} = oxygen partial pressure of the exhaust gas\end{matrix}$$

where:

E=electromotive force

R=universal gas constant

F=Faraday constant

T=absolute temperature of the gas

P_{O2}^{ref}=oxygen partial pressure of the reference gas

P_{O2}=oxygen partial pressure of the exhaust gas

Due to the large difference in oxygen partial pressure between fuel rich and fuel lean exhaust conditions, the electromotive force (emf) changes sharply at the stoichiometric point, giving rise to the characteristic switching behavior of these sensors. Consequently, these potentiometric oxygen sensors indicate qualitatively whether the engine is operating fuel-rich or fuel-lean, conditions without quantifying the actual air-to-fuel ratio of the exhaust mixture.

Further control of engine combustion can be obtained using amperometric mode exhaust sensors, where oxygen is electrochemically pumped through an electrochemical cell using an applied voltage. A gas diffusion-limiting barrier creates a current limited output, the level of which is proportional to the oxygen content of the exhaust gas. These sensors typically consist of two or more electrochemical cells; one of these cells operates in potentiometric mode and serves as a reference cell, while another operates in amperometric mode and serves as an oxygen-pumping cell. This type of sensor, known as a wide range, lambda, or linear air/fuel ratio sensor, provides information beyond whether the exhaust gas is qualitatively rich or lean; it can quantitatively measure the air/fuel ratio of the exhaust gas.

The electrolyte commonly used in exhaust sensors is yttria-stabilized zirconia. This material is an excellent oxygen ion conductor under various exhaust conditions. The electrodes are typically platinum-based and are porous in structure to enable oxygen ion exchange at electrode/electrolyte/gas interfaces. These platinum electrodes may be co-fired or applied to a fired (densified) electrolyte element in a secondary process, such as sputtering, plating, dip coating, etc. Co-fired electrodes are often used in planar type sensor elements, in which the electrodes may reside between laminated layers, where many secondary processes are not accessible. In this case, a thick film paste may be screen printed onto unfired (green) ceramic tape and dried. The screen-printed tapes are then stacked, laminated, cut, and fired to make sensor elements.

A sensor's performance is based on the ability to achieve a faster light-off time at start-up. A heater elevates the sensor's temperature to provide ample conditions for the sensor to operate. Conventional planar sensors are equipped with an integral heater located at the opposing end of the sensor or as a distinctly separate device. This heating from one direction causes a significant temperature gradient across the sensor element producing stress, particularly in sensor designs that are more complex and having multiple cell structures, materials, and supporting electrodes and chambers.

What is needed in the art is a gas sensor that provides a method of substantially uniformly heating an oxygen sensor.

### SUMMARY

The deficiencies of the above-discussed prior art are overcome or alleviated by the gas sensor with uniform heating and method of making the same.

A method of making a gas sensor is disclosed, comprising disposing an electrochemical cell comprising a sensing electrode and a reference electrode disposed in ionic communication with and on opposite sides of an electrolyte layer. A first insulating layer is disposed in contact with the sensing electrode. A second insulating layer is disposed in contact with the reference electrode. A first protective insulating layer and a first heater are disposed in contact and in thermal communication with the first insulating layer. A second protective insulating layer and a second heater are disposed in contact with and in thermal communication with the second insulating layer. The method includes forming a sensor and co-firing the sensor. A gas sensor is also disclosed as being made according to the above-referenced method.

### BRIEF DESCRIPTION OF THE DRAWINGS

Referring now to the figure, which is meant to be exemplary, not limiting.

FIG. 1 is an expanded isometric view of a simple gas sensor design.

### DETAILED DESCRIPTION OF THE PREFERRED EMBODIMENT

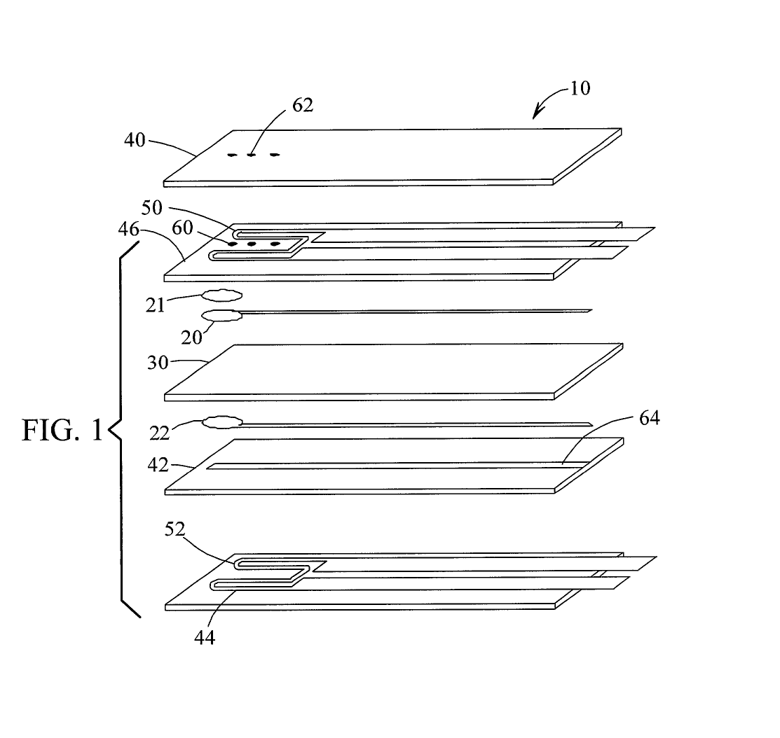

Referring to FIG. 1, the sensor element 10 is illustrated. More sophisticated (and multiple) cell structures and thus, sensors can be created, but for purposes of clarity, this uniform heating method will be demonstrated on a simple one-cell stoichiometric sensor element. The sensing (or exhaust gas) electrode 20 and the reference (or reference gas) electrode 22 are disposed on opposite sides of, and adjacent to, a solid electrolyte layer 30 creating an electrochemical cell (20/30/22). A porous protective membrane 21 can be disposed on sensing electrode 20. On the side of the sensing electrode 20 opposite solid electrolyte 30 are a protective insulating layer 40 and an insulating layer 46. Both layers 46, 40 have a porous area and/or an orifice 60, 62, respectively, which enables fluid communication between the sensing electrode 20 and the exhaust gas. One or more insulating layers 42 and an additional protective layer 44 are disposed on an opposite side of reference electrode 22 from the electrolyte layer 30. An air reference channel 64 can be disposed in contact with reference electrode 22 and insulating layer 42. Heaters 50, 52 are disposed on protective layers 40, 44, respectively, for maintaining sensor element 10 at the desired operating temperature. Although one electrochemical cell (20/30/22) is illustrated, multiple electrochemical cells are contemplated.

In addition to the above sensor components, conventional components can be employed, including but not limited to protective coatings (e.g., spinel, alumina, magnesium aluminate, and the like, as well as combinations comprising at least one of the foregoing coatings), lead gettering layer(s), leads, contact pads, ground plane(s), support layer(s), additional electrochemical cell(s), and the like. The leads, which supply current to the heaters and electrodes, are typically formed on the same layer as the heater/electrode to which they are in electrical communication and extend from the heater/electrode to the terminal end of the gas sensor where they are in electrical communication with the corresponding via (not shown) and appropriate contact pads (not shown).

The electrolyte layer 30 can comprise the entire layer or a portion thereof, can be any material that is capable of permitting the electrochemical transfer of oxygen ions, should have an ionic/total conductivity ratio of approximately unity, and should be compatible with the environment in which the gas sensor will be utilized (e.g., up to about 1,000° C.). Possible electrolyte materials can comprise any material conventionally employed as sensor electrolytes, including, but not limited to, zirconia which may optionally be stabilized with calcium, barium, yttrium, magnesium, aluminum, lanthanum, cesium, gadolinium, and the like, as well as oxides, alloys, and combinations comprising at least one of the foregoing materials. For example, the electrolyte can be alumina and yttrium stabilized zirconia. Typically, the electrolyte, which can be formed via many conventional processes (e.g., die pressing, roll compaction, stenciling and screen printing, tape casting techniques, and the like), has a thickness of up to about 500 microns or so, with a thickness of about 25 microns to about 500 microns preferred, and a thickness of about 50 microns to about 200 microns especially preferred.

It should be noted that the electrolyte layer 30 can comprise an entire layer (as is preferred herein) or a portion thereof; e.g., it can form the layer, be attached to the layer (electrolyte abutting dielectric material), or disposed in an opening in the layer (electrolyte can be an insert in an opening in a dielectric material layer). The latter arrangement eliminates the use of excess electrolyte and protective material, and reduces the size of the gas sensor by eliminating layers. Any shape can be used for the electrolyte, with the size and geometry of the various inserts, and therefore the corresponding openings, being dependent upon the desired size and geometry of the adjacent electrodes. It is preferred that the openings, inserts, and electrodes have a substantially compatible geometry such that sufficient exhaust gas access to the electrode(s) is enabled and sufficient ionic transfer through the electrolyte is established.

The electrodes 20, 22, are disposed in ionic contact with the electrolyte layer 30. Conventional electrodes can comprise any catalyst capable of ionizing oxygen, including, but not limited to, platinum, palladium, osmium, rhodium, iridium, gold, ruthenium, zirconium, yttrium, cerium, calcium, aluminum, and the like, silicon, and the like, as well as oxides, mixtures, and alloys comprising at least one of the foregoing catalysts. As with the electrolyte, the electrodes 20, 22 can be formed using conventional techniques. Some possible techniques include sputtering, painting, chemical vapor deposition, screen printing, and stenciling, among others. If a co-firing process is employed for the formation of the sensor, screen printing the electrodes onto appropriate tapes is preferred due to simplicity, economy, and compatibility with the co-fired process.

Insulating layers 42, 46 and protective layers 40, 44, provide structural integrity (e.g., protect various portions of the gas sensor from abrasion and/or vibration, and the like, and provide physical strength to the sensor), and physically separate and electrically isolate various components. The insulating layer(s), which can be formed using ceramic tape casting methods or other methods such as plasma spray deposition techniques, screen printing, stenciling and others conventionally used in the art, can each be up to about 200 microns thick or so, with a thickness of about 50 microns to about 200 microns preferred. Since the materials employed in the manufacture of gas sensors preferably comprise substantially similar coefficients of thermal expansion, shrinkage characteristics, and chemical compatibility in order to minimize, if not eliminate, delamination and other processing problems, the particular material, alloy or mixture chosen for the insulating and protective layers is dependent upon the specific electrolyte employed. Typically these insulating layers comprise a dielectric material such as alumina, and the like.

Disposed between the protective layer 40 and the insulating layer 46 and between the insulating layer 42 and the protective layer 44, are heaters 50, 52, respectively, that are employed to maintain the sensor element 10 at the desired operating temperature. Heaters 50, 52 can be any conventional heater capable of maintaining the sensor end at a sufficient temperature to facilitate the various electrochemical reactions therein. Preferably, two heaters are used, although using more than two heaters is also contemplated. Preferably, the heaters 50, 52 have a serpentine design, as illustrated in FIG. 1. The heaters 50, 52, which are typically platinum, palladium, and the like, as well as oxides, mixtures, and alloys comprising at least one of the foregoing metals, or any other conventional heater, are generally screen printed or otherwise disposed onto a substrate to a thickness of about 5 microns to about 50 microns. Although the heaters can have substantially equivalent resistance, different resistance can be employed to create a desired thermal gradient across the sensor.

Electrical connection between the heaters 50, 52 can be achieved through the use of vias (not shown) that can connect to an external power source. An alternative connection can be completed through the use of vias that extend the leads of each heater to the exterior of the sensing element. The leads can then be connected through the use of a conductive print along the edge of the sensing element overlapping a contact pad for each heater lead or in the alternative, an external clip can be used to connect these pads.

In order for the sensing element 10 to operate, exhaust gas needs to pass through protective layer 40, pass by heater 50 to the sensing electrode 20. This is achieved, preferably, with the orifice 60 disposed in the layers 40, 46. Orifice 60, 62 can be formed by punching holes or depositing a fugitive material, e.g. carbon base material such as carbon black, in a punched hole in layers 40, 46, such that, upon processing, the material burns out and leaves a void.

Through the orifice 60, exhaust gas comes in contact with the sensing electrode 20. Preferably, sensing electrode 20 has a porous protective layer (or membrane) 21 disposed directly onto the electrode. The porous protective layer can be any material that acts as a barrier for contaminants, including aluminum, magnesium, and the like, as well as oxides, alloys, and combinations comprising at least one of the foregoing materials. The sensor comprising the above-described components can be formed by co-firing. For example, a “green sensor” can be formed comprising a sensing electrode and a reference electrode disposed by sputtering or the like on opposite sides of an electrolyte, forming the electrochemical cell. An insulating layer is disposed in contact with both the reference and the sensing electrode. Heaters are disposed, by sputtering or the like, on the protective insulating layers and joined with the insulating layers disposed on either side of the electrochemical cell, completing the formation of the “green sensor”. The “green sensor” is then fired to temperatures of up to about 1,550° C. and cooled, creating the sensor.

By disposing two heaters in a sensor, effective heating of the sensor is achieved, minimizing any thermal gradients and thus the stress under operating conditions. The dual heater sensor experiences an ability to achieve a faster performance than a conventional sensor. When exposed to a very cold and a very high flow rate exhaust, a conventional single heater sensor has a temperature difference of about 100° C. between the heater side and the sensor side. While the temperatures of the dual heater sensor have a temperature difference of less than about 20° C. from one side of the device to the other. This uniform heating allows for faster heating of the substrate without increasing the stress on the ceramic substrate.

In linear sensors, where temperatures need to be accurately controlled and maintained, a temperature difference between the temperature feedback cell and the diffusion restriction channel of about 40° C. (for a single heater), can result in a measurement error of about 1.4%, while a dual heater linear sensor with a temperature difference of about 5° C. can result in a measurement error of about 0.2%. Therefore, the improvement of providing a better temperature uniformity results in an improvement on accuracy of about 85% (from 1.4% error to 0.2% error).

Due to greater thermal uniformity, the stress on the dual heater sensor is reduced, when compared to a single heater sensor. The amount of stress is reduced from greater than about 90 megapascals (MPa) for a single heater sensor to less than about 50 MPa with a dual heater sensor. Ideally, the stress for the dual heater sensor, having substantially equivalent resistances, is about 30 MPa or less, with about 10 MPa to about 30 MPa preferred, and with about 10 MPa to about 15 MPa especially preferred. With sensors having two heaters of different resistances of 50%, there is a slight increase in the stress from about 10 MPa to about 30 MPa. This indicates that heaters of different resistance values can be used together in a dual heating sensor while still maintaining a low stress value.

A sensor with two heaters also enables faster sensor activation from cold start and longer durability due to the lower stress. During a cold start, a sensor with one heater is subject to a higher stress, which may result in cracking in severe environments with typical heating. The traditional approach to avoid this cracking is to apply power regulation, namely limiting the heating rate, during a cold start. In a sensor with two heaters, the allowable heating rate can be faster while still in the safe stress level. Therefore, the faster sensor activation and longer durability are achieved.

While preferred embodiments have been shown and described, various modifications and substitutions may be made thereto without departing from the spirit and scope of the invention, including the use of the geometries taught herein in other conventional sensors. Accordingly, it is to be understood that the apparatus and method have been described by way of illustration only, and such illustrations and embodiments as have been disclosed herein are not to be construed as limiting to the claims.

What is claimed is:

1. A method of making a gas sensor, comprising:
disposing an electrochemical cell comprising a sensing electrode and a reference electrode disposed in ionic communication with and on opposite sides of an electrolyte layer;
disposing a first insulating layer in contact with said sensing electrode;
disposing a second insulating layer in contact with said reference electrode;
disposing a first protective layer in contact with said first insulating layer;
disposing a second protective layer in contact with said second insulating layer;
disposing a first heater in thermal communication with said first protective layer;
disposing a second heater in thermal communication with said second insulating layer;
forming a sensor; and
co-firing said sensor.

2. The method of claim 1, further comprising disposing an orifice in said first insulating layer.

3. The method of claim 2, further comprising disposing an orifice in said first protective layer.

4. The method of claim 1, further comprising disposing a porous membrane over said sensing electrode.

5. The method of claim 4, wherein said porous membrane is selected from the group consisting of aluminum, magnesium, as well as alloys, oxides, and combinations comprising at least one of the foregoing materials.

6. The method of claim 1, wherein said first heater and said second heater have substantially equivalent resistance values.

7. The method of claim 6, wherein said first heater and said second heater reduce the stress level in said sensor to about 30 MPa or less.

8. The method of claim 7, wherein said first heater and said second heater reduce the stress level in said sensor to about 15 MPa to about 30 MPa.

9. The method of claim 1, wherein said first heater and said second heater have different resistance values.

10. The method of claim 1, further comprising disposing a third heater in thermal communication with said electrochemical cell.

11. A gas sensor created according to the method of claim 1.

12. A method of using a sensor, comprising:
exposing a co-fired sensor comprising a first heater in thermal communication with a protective layer and a second heater in thermal communication with an insulating layer, to a gas;
creating an electromotive force; and
measuring said electromotive force.

13. The method of claim 12, further comprising disposing an orifice in said protective layer.

14. The method of claim 12, wherein said first heater and said second heater have substantially equivalent resistance values.

15. The method of claim 14, wherein said first heater and said second heater reduce the stress level in said sensor to about 30 MPa or less.

16. The method of claim 15, wherein said first heater and said second heater reduce the stress level in said sensor to about 15 MPa to about 30 MPa.

17. The method of claim 12, wherein said first heater and said second heater have different resistance values.

18. The method of claim 12, further comprising a third heater disposed in said co-fired sensor.

19. A method of using a sensor, comprising:
exposing a co-fired sensor to a gas;
controlling a thermal gradient across said sensor;
creating an electromotive force; and
measuring said electromotive force.

20. The method of claim 19, wherein said sensor comprises a sensing electrode and a reference electrode disposed in ionic communication with and on opposite sides of an electrolyte layer creating an electrochemical cell.

21. The method of claim 19, further comprising heating said sensor with at least two heaters, wherein said heaters are disposed on opposite sides of said electrochemical cell.
